(19) United States
(12) Patent Application Publication
(10) Pub. No.: US 2018/0292542 A1
(43) Pub. Date: Oct. 11, 2018

(54) SYSTEM AND METHOD TO FACILITATE MONITORING AND TRACKING OF PERSONNEL IN A CLOSED OPERATIONAL NETWORK

(71) Applicant: Amit ANAND, Edmonton (CA)

(72) Inventor: Amit ANAND, Edmonton (CA)

(21) Appl. No.: 15/570,744

(22) PCT Filed: Apr. 29, 2016
(86) PCT No.: PCT/IB2016/052428

§ 371 Date: Oct. 30, 2017

Related U.S. Application Data
(60) Provisional application No. 62/155,786, filed on May 1, 2015.

(51) Int. Cl. G01S 19/46; G01S 5/14; H04W 4/80

(52) U.S. Cl. CPC G01S 19/46; H04W 4/80; G01S 5/14

(57) ABSTRACT

A system for monitoring and tracking of personnel in a closed operational network is provided. The system includes a database to store and retrieve profiles of the personnel. The system also includes a plurality of Bluetooth Low Energy (BLE) based identification tags linked to the profiles of each of the personnel, and one or more BLE based receivers positioned at one or more strategic locations in the closed operational network to generate first signals in response to a detection of the one or more identification tags. The system further includes a processing unit to receive the one or more first signals from the one or more receivers. The processing unit further records, in the database, one or more first entries indicative of a presence of the one or more personnel with respect to the one or more strategic locations, based on the one or more first signals.

### CROSS REFERENCE TO RELATED APPLICATIONS

This application is a non-provisional application of provisional application Ser. No. 62/155,786, entitled “A SYSTEM AND METHOD OF TRACKING PASSENGERS ON A TRANSIT SYSTEM” filed May 1, 2015, The subject matter in the above-identified co-pending and commonly owned application(s) is incorporated herein by reference.

### TECHNICAL FIELD

The present disclosure generally relates to managing a closed operational network, and more specifically relates to a system and method to facilitate monitoring and tracking of personnel in a closed operational network.

### BACKGROUND

Many schools may have hundreds of students who take a ride to and from the school on buses every school day. Every parent may have faced one or the other problem with the school bus, such as the school bus did not arrive on time, the bus did not show up at all, or the time or place of a bus stop has changed without notification to the parents. Also, parents have no easy ways to track the whereabouts of their child on route to or back from the school, or getting a confirmation whether their child have reached the school safely. Calling the driver or the school administration may be an option, but is very cumbersome and time-consuming.

Parents have also become increasingly concerned about the safety of their children, especially when the children traverse to and from school premise and their respective bus stops. It is a general concern that the current school networks lack adequate safety systems for the tracking and monitoring of school children and school buses. For example, present school networks, generally, manually validate each student at the time of boarding and de-boarding of the school bus, which is prone to errors because of human factor.

Moreover, present school networks mostly rely on phone or text-based communication systems for sending and receiving updates from a driver of a school bus about any delay (for example, due to a technical fault), change in planned route (for example, due to a block road), etc. Such communication systems are slow and unreliable to respond to any unforeseen event, and more critically during an emergency. However, the societies at all levels attach great importance and concern for the children safety. Therefore, there is a need to develop some automated systems using latest technologies to provide easy and reliable means for monitoring and tracking of students in a school network.

Similarly there is a need of such monitoring and tracking systems in other industries. For example, in present times, large corporations include hundreds of personnel performing tasks at one or more work sites. Most of these personnel come from multiple locations and commute daily to assigned worksites. Such corporations often provide transport facilities to pick and drop these personnel from their respective homes to the worksite, and vice-versa. One example of such corporation is oil and gas companies. Oil and gas companies employ numerous camp workers who are transported to and from the work site at remote locations. Therefore, such companies would also appreciate the need of systems and methods which can provide easy and reliable means for monitoring and tracking of personnel in a closed operation network.

### SUMMARY

In one aspect, a computer based system implemented to facilitate monitoring and tracking of personnel in a closed operational network is described. The computer based system includes a database configured to store and retrieve profiles of the personnel. The computer based system also includes a plurality of Bluetooth Low Energy (BLE) based identification tags, such that each of the plurality of identification tags is linked to the profile of one of the personnel. The computer based system further includes one or more BLE based receivers positioned at one or more strategic locations in the closed operational network, such that the one or more receivers are configured to generate one or more first signals in response to a detection of the one or more identification tags. The computer based system also includes a processing unit in communication with the database and the one or more receivers. The processing unit is configured to receive the one or more first signals from the one or more receivers. The processing unit is further configured to record, in the database, one or more first entries indicative of a presence of the one or more personnel with respect to the one or more strategic locations, based on the one or more first signals.

In another aspect, a method of monitoring and tracking of personnel in a closed operational network is described. The method includes creating a database having profiles of a plurality of the personnel. The method further includes linking an identification tag to the profile of one of the personnel. The method further includes positioning one or more receivers at one or more strategic locations in the closed operational, such that the one or more receivers are configured to detect the identification tags in proximity thereof. The method further includes generating one or more first signals in response to the detection of the identification tags. The method further includes recording, in the database, one or more first entries indicative of a presence of the one or more personnel with respect to the one or more strategic locations, in response to the one or more first signals.

In yet another aspect, a computer based system implemented to facilitate navigation of personnel in a closed operational network is provided. The system includes a plurality of identification tags. Each of the plurality of identification tags is associated with each of the personnel. The system further includes one or more receivers positioned at one or more strategic locations in the closed operational network. The one or more receivers are configured to detect the identification tags in proximity thereof. The one or more receivers are configured to generate a first signal in response to a detection of the identification tag. The system further includes a processing unit in communication with the one or more receivers. The processing unit is configured to deliver navigation information to a display associated with the identification tag of the personnel in response to the first signal, such that the navigation information is based on the strategic location corresponding to the first signal.

The details of one or more implementations are set forth in the accompanying drawings and the description below. Other aspects, features and advantages of the subject matter disclosed herein will be apparent from the description, the drawings, and the claims.

### BRIEF DESCRIPTION OF THE DRAWINGS

FIG. 1 illustrates a schematic planar representation of a closed operational network, such as a school network, in accordance with one or more embodiments of the present disclosure;

FIG. 2 illustrates a block diagram of a computer based system implemented in the closed operational network of FIG. 1, in accordance with one or more embodiments of the present disclosure;

FIG. 3 illustrates a block diagram of a processing unit for computer based system of FIG. 2, in accordance with one or more embodiments of the present disclosure;

FIG. 4a-4c illustrates some exemplary screenshots of a mobile application, part of the computer based system of FIG. 2, in accordance with one or more embodiments of the present disclosure; and

FIG. 5 illustrates a flow chart depicting the steps involved in a method for monitoring and tracking of personnel in the closed operational network, in accordance with one or more embodiments of the present disclosure.

### DETAILED DESCRIPTION

Detailed embodiments of the present disclosure are described herein; however, it is to be understood that disclosed embodiments are merely exemplary of the present disclosure, which may be embodied in various alternative forms. Specific process details disclosed herein are not to be interpreted as limiting, but merely as a basis for the claims and as a representative basis for teaching one skilled in the art to variously employ the present disclosure in any appropriate process for creating digital content.

Although the exemplary embodiments will be generally described in the context of software modules running in a distributed computing environment, those skilled in the art will recognize that the present invention also can be implemented in conjunction with other program modules for other types of computers. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the Internet.

The detailed description which follows is represented largely in terms of processes and symbolic representations of operations in a distributed computing environment by conventional computer components, including remote file servers, remote computer servers, remote memory storage devices, a processing unit, memory storage devices, display devices and input devices. Each of these conventional distributed computing components is accessible by the processing unit via a communications network.

The processes and operations performed by the computer include the manipulation of signals by a processing unit or remote server and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art.

The present invention also includes a computer program which embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the flow charts and associated description in the application text. Therefore, disclosure of a particular set of program code instructions is not considered necessary for an adequate understanding of how to make and use the invention.

Neither the Title (set forth at the beginning of the first page of the present application) nor the Abstract (set forth at the end of the present application) to be taken as limiting in any way as the scope of the disclosed invention. An Abstract has been included in this application merely because an Abstract of not more than 150 words is required under 37 C.F.R. Section 1.72(b) or similar law in other jurisdictions. The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The terms “including”, “comprising” and variations thereof mean “including but not limited to”, unless expressly specified otherwise.

The terms “a”, “an” and “the” mean “one or more”, unless expressly specified otherwise. The term “plurality” means “two or more”, unless expressly specified otherwise.

A reference to “another embodiment” or “another aspect” in describing an embodiment does not imply that the referenced embodiment is mutually exclusive with another embodiment (e.g., an embodiment described before the referenced.

The inventive functionality of the claimed system will be explained in more detail in consideration of the following description read in conjunction with the appended figures. For the purpose of the present disclosure, the invention has been explained, in detail, in terms of a school network; however a person having ordinary skill in the art may contemplate that the teachings may be applied to any closed operational network. Hereinafter, the terms “closed operational network” and “school network” have been interchangeably used without any limitations. Further, the terms “personnel” and “students” have been interchangeably used without any limitations.

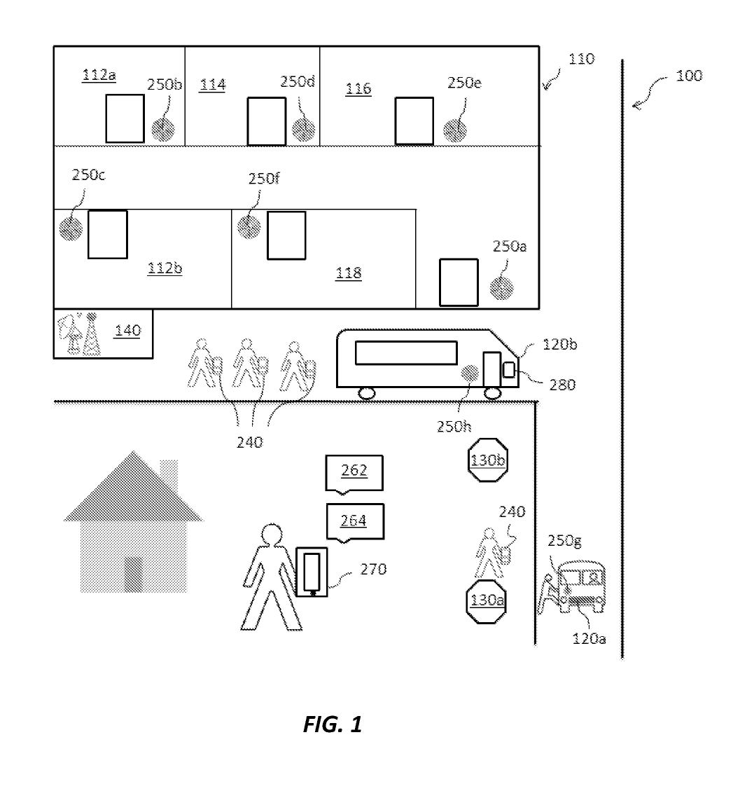

FIG. 1 illustrates a schematic representation of a school network, generally referenced by the numeral 100, according to one or more embodiments of the present disclosure. The term “school network” has been used as an umbrella term to encompass all the relevant areas, constituents and constructions related to journeys of the students for a given school day. Some of the designated relevant areas, constituents and constructions defined herein, are collectively referred to as “strategic locations”. The strategic locations may include, but not limited to, school premises 110 having classrooms 112, sports complex 114, canteen 116, medical dispensary 118, etc.; school buses 120; one or more stops 130; and the like. In some examples, the strategic locations may include, for example, multiple classrooms (referenced as 112a, 112b, . . . , so on), multiple buses (referenced as 120a, 120b, . . . , so on), and multiple stops (referenced as 130a, 130b, . . . , so on). Further, each of the strategic locations includes an entry and an exit. For the purpose of the specification, it is assumed that each of the strategic location has a common entry and exit, referred to as “access”. It may be understood that the relative positions and distances between various objects as shown in FIG. 1 are exemplary only and do not limit the scope of the present disclosure.

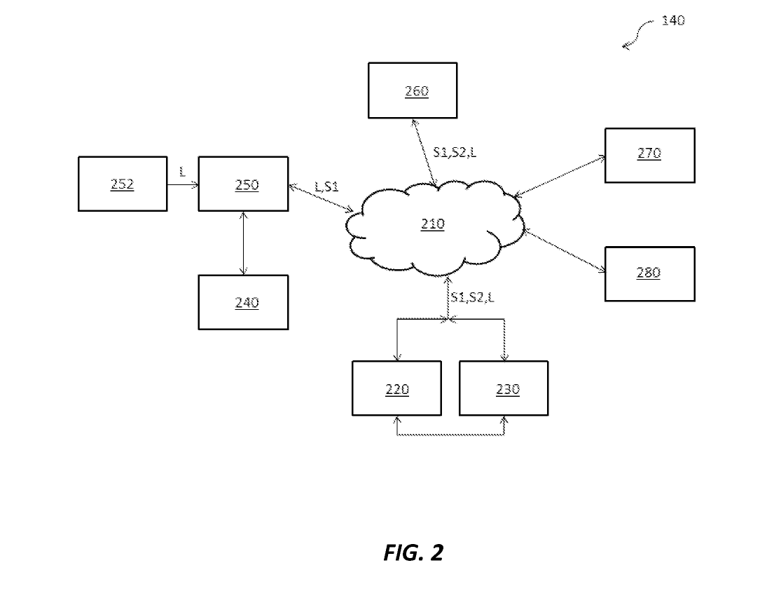

The school network 100, as illustrated in FIG. 1, is provided with exemplary computer based system 140 for implementing processes of the school network 100. It may be understood that the representation or position of the computer based system 140, as shown in FIG. 1, is for illustration purposes only and should not be construed as limiting to the invention in any manner. Further it may be understood that the computer based system 140 may encompass any system which uses computing devices, including, but not limited to, mobile based system, PC based system with web applications, etc. FIG. 2 illustrates an exemplary block diagram of the computer based system 140, according to one or more embodiments of the present disclosure. The computer based system 140 may include various sub-systems or components disposed throughout the school network 100. The computer based system 140 makes use of several interoperating components in communication with each other, some of which are shown in FIG. 1 as well.

In the computer based system 140, at least some of the interoperating components may be communicating with each other through a network 210, as illustrated. The network 210, in one embodiment, may be implemented as a single network or a combination of multiple networks. For example, in various embodiments, the network 210 may include the Internet and/or one or more intranets, and/or other appropriate types of communication networks. In another example, the network 210 may be a wireless telecommunications network (e.g., Wi-Fi, Li-Fi, cellular phone network) adapted to communicate with other communication networks, such as the Internet. Further, the network 210 of the present disclosure may utilize sophisticated encryption technologies to protect against the data theft, or the like.

The computer based system 140 may include a database, schematically represented and referenced by the numeral 220. The database 220 may be configured to handle data management, including user accounts, group state and statistics, lead history, among other data. Preferably, the database 220 is configured to handle large amounts of data spread across many commodity servers to provide a reliable service with no single point of failure. In one or more embodiments of the present disclosure, the database 220 may be configured to store a plurality of profiles of the students. In some examples, the database 220 may store the plurality of profiles of the students using, for example, Cassandra (available from http://cassandra.apache.org), Hadoop (available from http://hadoop.apache.org), MongoDB® (available from 10gen, Inc.) or MySQL™ (available from http://www.mysql.com).

In one or more embodiments, the database 220 may be configured to retrieve the plurality of profiles of the students. For this purpose, the database 220 may use a database management system (not shown). Examples of database management system for controlling, maintaining and using the database 220 include MongoDB® and Cassandra. MongoDB® is a scalable, high-performance, open-source NoSQL database management system that provides powerful replication and high availability, allowing horizontal scaling without compromising functionality. In addition, NoSQL database management systems are suitable for databases requiring many writes and sequential reads. This is in contrast to relational databases, such as MySQL, which are good for relational queries, but perform poorly for frequent writes and sequential reads, especially for massive quantities of data. Such a database management system provides many features well-suited to enabling collaboration groups, including rich, document-based queries, flexible aggregation and data processing, and the ability to store files of any size without complicating the stack.

The computer based system 140 may further include a web based platform 230. In some embodiments, the database 220 may be a part of a stand-alone database server communicatively coupled to the web based platform 230. The web based platform 230 is configured to provide school administration (or, an admin of the school network 100) to manage, including accessing, retrieving and editing, of the database 220. For this purpose, the web based platform 230 may include any applicable web server such as, for example, Apache™ (available from http://httpd.apache.org), Node.js (available from http://nodejs.org/), Twisted (available from http://twistedmatrix.com), MongreL2™ (available from http://mongrel2.org), that supports a web application framework (e.g., Django® (available from Django Software Foundation) or Node.js™ (available from http://nodejs.org/)). The web based platform 230 provides services such as, for example, authentication, dynamic webpage generation, and an interface front end to the database 220. Django® is a powerful WebApplication Framework, providing support for numerous backend databases, powerful authentication, dynamic webpage generation, and URL-address parsing. As Django is written in Python, a powerful scripting language, it is well suited for parsing and manipulating various forms of text-based data, such as HTML, XML and human-readable data, like chat messages.

In one embodiment, the computer based system 140 may include a plurality of identification tags 240. The identification tags 240 may basically be a transmitter broadcasting identification information. It may be understood that the identification tag 240 may be anything that is readable by a reader of any kind that exist independently or a-priori of the computer based system 140. In one example, the identification tag 240 may be a smart or fixed tag that leverages an existing hardware element and enables communication with the system through software configuration of that hardware. In one example, the identification tags 240 may be in the form of small stickers integrated with identification cards that are anyways carried by the students for identification purposes in the school. The identification tag 240 may be attached to the existing identification cards of the students by adhesive means, such as tape or glue.

Further, the computer based system 140 may include one or more receivers 250. The receivers 250 are basically readers or collection of one or more readers that can manipulate tags. The receiver 250 may be any wireless device that may communicate with tags or other readers; communicates with the smart device application; and/or communicates with the network 210 (as illustrated in FIG. 2). The receiver 250 may provide indications and get information and configuration/control from a user, through a GUI or other UI; which may be the web based platform 230. In one embodiment of the present disclosure, the receivers 250 validates the existence of identification tags 240 within a certain area; and further estimate the position, range, direction and orientation of identification tags 240 relative to itself. In some examples, the receivers 250 may further send and/or receive information from identification tags 240 (e.g. tag sensor information); and estimates its own position (indoor or outdoor) and orientation, and other value add information required by an application (acceleration, etc.).

In a preferred embodiment, the identification tags 240 and the receivers 250 are Bluetooth Low Energy based devices. Bluetooth Low Energy (also referred to as “Bluetooth LE” or “BLE”) is a radio technology that is becoming a common communication standard in mobile devices and various battery-operated devices. The BLE based device occupies limited space, processing and/or power resources, and thus, may communicate using a low power consumption/capacity wireless communication medium. Bluetooth LE has been integrated into the Bluetooth Core 4.0 specification and provides a Link Layer capable of providing ultra-low power idle mode operation, simple device discovery, and reliable point-to-multipoint data transfer with advanced power-save and secure encrypted connections at the lowest possible cost.

According to an embodiment of the present disclosure, the identification tags 240 may be based on the iBeacon™ technology developed by Apple Corporation. iBeacons are noteworthy as background for the present invention because they are portable and are utilizing lightweight Bluetooth Low energy transmitters to communicate with other devices such as smartphones at 2.4 MHz and at ranges from less than one foot (<1 foot) and up to 230 feet depending on location, settings, and structural or environmental interference. Further, the receivers 250 may be a smartphone or similar device which acts as a reader for receiving BLE signals from the beacons of the identification tags 240. In particular, the receiver 250 may be any Android™ or iOS™ or Windows™ based device with a Bluetooth™ chip embedded therein and having relevant app configured for communication with the beacons of the identification tags 240 in the school network 100.

While various embodiments of the present disclosure have been described using Bluetooth LE, the use of this communication standard is not intended to limit the present invention. On the contrary, it is conceivable that the various embodiments of the present disclosure may be implemented using alternative wireless mediums. For example, the system 140 may use any other form of contactless communication standard between the identification tags 240 and the receivers 250, such as, RFID, ZigBee, etc. It is preferred that the contactless communication standard is implemented for the sake of convenience involved in validation and other steps of the process.

In one or more embodiments, the receivers 250 may be positioned at one or more strategic locations in the school network 100. For example, the receivers 250 may be positioned at or in proximity to “access” of; school premises 110, classrooms 112, sports complex 114, canteen 116, medical dispensary 118, school buses 120, and the like. In some examples, the receivers 250 may also be positioned at one or more stops 130. In the illustrated example, a receiver 250a is positioned at “access” to the school premises 110; a receiver 250b is positioned at “access” to the classroom 112a; a receiver 250c is positioned at “access” to the classroom 112b; a receiver 250d is positioned at “access” to the sports complex 114; a receiver 250e is positioned at “access” to the canteen 116; a receiver 250f is positioned at “access” to the medical dispensary 118; a receiver 250g is positioned at “access” to the school bus 120a; and a receiver 250h is positioned at “access” to the school bus 120b.

Further, in an embodiment, the computer based system 140 may include a processing unit 260. The processing unit 260 may include, but is not limited to, a general-purpose computing device that interacts with users/other components through the network 210. The processing unit 260 may be a server that communicates over a network with user devices. The processing unit 260 may include general-purpose computers, special-purpose computers, mainframes, gaming devices, tablet computers, smartphones, PDAs, and the like. The processing unit 260 may be implemented as a network of computer processors. In some implementations, the processing unit 260 may include multiple servers, mainframe computers, networked computers, or a similar type of systems or devices. In some implementations, the processing unit 260 may be a server farm or data center. Further in some implementations, the processing unit 260 may receive connections through a load-balancing server or servers. Also in some implementations, a task may be divided among multiple servers that are working together cooperatively.

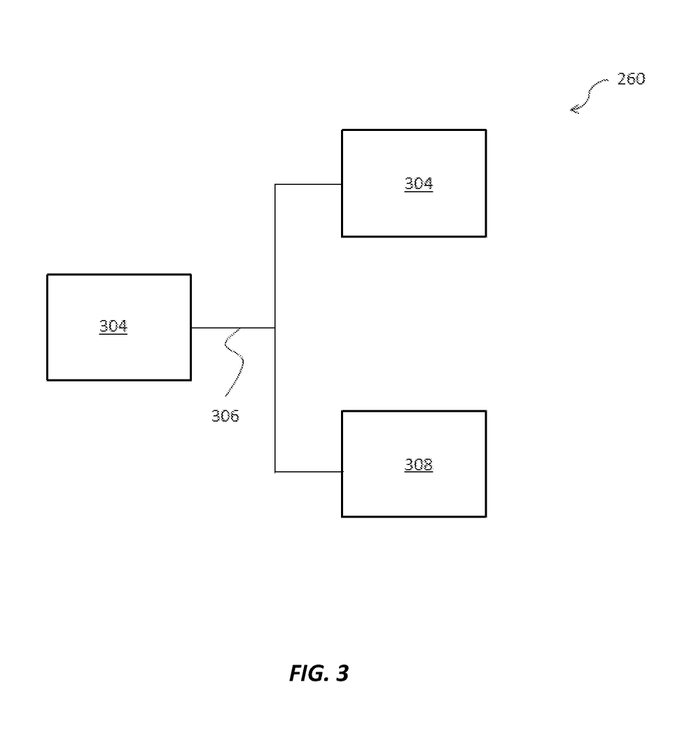

FIG. 3 illustrates a schematic block diagram of the processing unit 260, according to an exemplary embodiment of the present disclosure. As shown in FIG. 3, the processing unit 260 for implementing the method(s) of the present disclosure may include (but is not limited to) a general-purpose computing device in the form of a conventional computer, including a processor 302, a system memory 304, and a system bus 306 that couples various system components including the system memory 304 to the processor 302. The system memory 304 may include one or more suitable memory devices such as, but not limited to, RAM. The computer may include a storage medium 308, such as, but not limited to, a solid state storage device and/or a magnetic hard disk drive (“HDD”) for reading from and writing to a magnetic hard disk, a magnetic disk drive for reading from or writing to a removable magnetic disk, and an optical disk drive for reading from or writing to removable optical disk such as a CD-RW or other optical media, flash memory, etc. The storage medium 308 may be external to the computer, such as external drive(s), external server(s) including database(s), or the like. The drives and their associated computer-readable media may provide non-transient, non-volatile storage of computer-executable instructions, data structures, program modules, and other data for the computer to function in the manner described herein. Various embodiments employing software and/or Web implementations are accomplished with standard programming techniques.

Referring back to FIG. 2, in an embodiment, the one or more receivers 250 are configured to detect the identification tags 240 in proximity thereof, as discussed above. It may be understood that the receivers 250 may complete the detection of the identification tags 240 based on the information, stored locally, about the identification tags 240 (or specifically, a list of unique codes for each identification tags 240); or by retrieving the said information from the database 220, being in communication with via the network 210. Further, the one or more receivers 250 are configured to generate one or more first signals ‘S1’ in response to the detection of the one or more identification tags 240. The first signals ‘S1’ are transmitted to the processing unit 260, via the network 210.

In some examples, the receiver 250 may include network-based location determination capabilities. In other examples, the receiver 250 may not directly include any location determination capabilities, and in such cases, the computer based system 140 may include a location sensor 252 associated with each of the receivers 250. The location sensor 252 may be using one or a combination of Global Positioning System (GPS), Global Navigation Satellite System (GNSS), Galileo system, Beidou system, and triangulation or trilateration of cellular or Wi-Fi networks. The location sensor 252 may be configured to generate a location signal ‘L’ indicative of the location of the corresponding receiver 250. The generated location signal ‘L’ may be sent to the processing unit 260 via the network 210. The location sensor 252 may be capable of directly communicating with the processing unit 260 to transmit the location signal ‘L’, or use the communication means/channel of the corresponding receiver 250 or any other means. In some examples, the location sensor 252 may be configured to activate and generate the location signals only when the corresponding receiver 250 may generate the first signal ‘S1’. It may be understood that this is done so to save on power consumption, and thus increase battery life of the receiver 250 and/or the location sensor 252, the devices being portable devices. In some examples, such as when the receiver 250 is a smartphone, the receiver 250 may additionally and/or alternatively include cellular communications features capable of effecting (receiving and/or sending) cellular voice (i.e. telephonic) or data (wireless cellular data) communication. Such configurations may be used to allow for broadcasting emergency messages or the like, as and when a particular student needs to be called when he/she is at a particular location.

According to an embodiment of the present disclosure, the computer based system 140 may further include information about one or more assigned strategic locations for each student in the school network 100. In particular, the database 220 may include information about the assigned strategic locations for each student in the network 100. Such information may be stored in relation to the corresponding profiles of the students. The assigned strategic locations may include designated locations in the school network 100 where the student is expected to be at a certain point of time. For example, it is expected that the student will be at his/her designated stop 130 at the scheduled bus arrival time; or attend a particular classroom at some other time based on his/her class schedule. The school administration (or admin) may select the assigned strategic locations for each student in the school network 100, and may correspondingly store (and regularly update, if need be) the related information in the database 220. As discussed, the database 220 may be managed by using the web based platform 230, to define and edit the assigned strategic locations. Further, in some examples, the parents/guardians of the students may also have the option to designate certain assigned strategic locations for the corresponding student, such as, the designated stop 130 or the like. For this purpose, the parents/guardians of the students may be provided with remote access facilities to edit records of assigned strategic locations associated with the profile of the corresponding student.

In some embodiments, the processing unit 260 may be configured to receive the first signals ‘S1’ as generated by the receivers 250. Further, as discussed, the processing unit 260 may be configured to receive the location signal ‘L’ from the one or more receivers 250. The location signal ‘L’ may include information about the coordinates of the receiver 250. Further, the processing unit 260, in communication with the database 220, may be configured to receive the coordinates of the various assigned strategic locations for each of the student in the school network 100. In an embodiment, the processing unit 260 is configured to generate a second signal ‘S2’ in response to the location of the one or more receivers 250 matching one of the assigned strategic locations, or in other words if coordinates of the current location of the student (as detected and determined based on the first signal ‘S1’ and the location signal ‘L’) substantially matches with coordinates of any of the assigned strategic locations for that student. It may be understood that such a comparison is made only in case when the receiver 250 has generated the first signal ‘S1’, to avoid unnecessary computation. It may be contemplated that such embodiment may be most applicable when the students are in transit in the school bus 120. For example, when the school bus 120a may have reached a stop 130a and that stop 130a being a designated stop (assigned strategic location) for a particular student; and when that particular student checks-in or checks-out by validating his/her identification tag 240 at the receiver 250g, the processing unit 260 may generate the second signal ‘S2’. Therefore, as discussed, the second signal ‘S2’ is generated in response to receiving the corresponding first signal ‘S1’ upon validation.

In one or more embodiments, the processing unit 260 may be configured to create one or more first entries in the database 220, in response to receiving the first signal ‘S1’. It may be contemplated that the first entries are indicative of a presence of the one or more students with respect to the one or more strategic locations, in the school network 100. The first entries may include information about the time and coordinates when the validation takes place. The first entries may be recorded in the database 220 in cross-reference with the profiles of the corresponding students (for whom the given signal ‘S1’ is triggered). It may be understood that the processing unit 260 may access the database management system of the database 220, for recording the first entries. Similarly, the processing unit 260 may record one or more second entries in the database 220 in response to the second signal ‘S2’, and indirectly, based on the first signal ‘S1’. It may be contemplated that the second entries may be indicative of the presence of the student with respect to the one or more assigned strategic locations for the corresponding student. Again, the second entries may be recorded by implementing the same means as used for recording of the first entries, in the computer based system 140 of the present disclosure.

In one embodiment, the processing unit 260 may be also be configured to generate a first set of notifications 262, having information about a particular student entering or exiting the one or more assigned strategic locations defined in his/her profile. As may be understood, the first set of notifications 262 may be generated in response to and based on the second entries recorded in cross-reference to the profile of that particular student. In some embodiments, the processing unit 260 may further be configured to generate a second set of notifications 264, having information about one or more of a current location of the student, an expected arrival time of the student at the assigned strategic location, and updates due to any delay in the expected arrival time, based on the location signal ‘L’. A person of ordinary skill in the art may appreciate that generating the second set of notifications 264 may involve, analyzing the data received from the various receivers 250 and the location sensors 252. Such computation schemes are widely known in the art and thus have not been described herein in detail for the sake of brevity of the present specification.

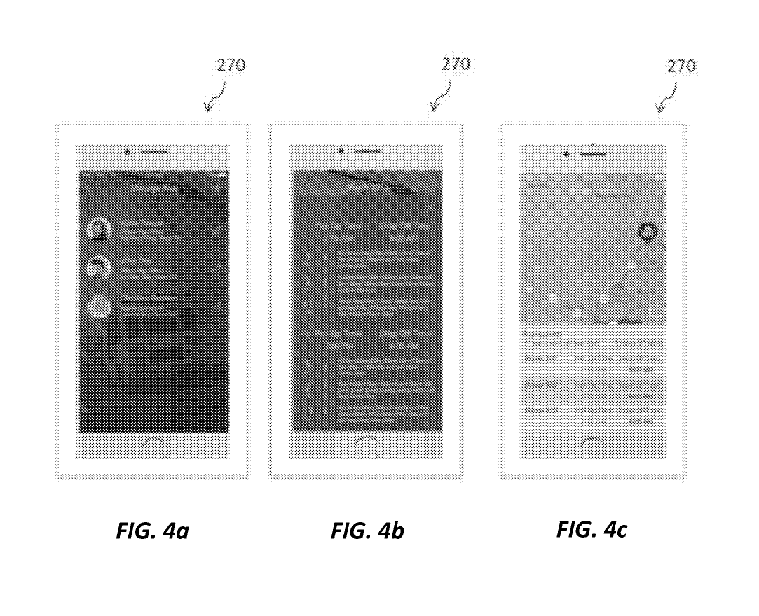

In an embodiment, the computer based system 140 may further include a mobile application 270. FIG. 4a-4c illustrate some exemplary screenshots of the mobile application 270, in accordance with one or more embodiments of the present disclosure. Typically, the mobile application 270 can be installed and run on any mobile/handheld device designed and configured to support the mobile application (e.g. iPhone™, iPad™, any other smartphone, tablet computer, PDA and the like). Further, the mobile application 270 may be executable on any known platforms, such as, Android™, iOS™, Windows™, etc. The mobile application includes computer-readable instruction/logic embodied in software and/or firmware and/or hardware and stored on computer-readable memory component. Such a memory component may be a read-only memory, random access memory, non-volatile memory, volatile memory, static memory, dynamic memory, flash memory, cache memory, and/or any device that stores digital information. The computer-readable instructions/logic can be processed by an appropriate computational system.

In one embodiment, the mobile application 270 may be configured to be associated with the one or more profiles of the students. Such configuration involving association of the mobile application 270 with more than one profile of students may be applicable for parents/guardians who may have more than one student as part of the school network 100. The mobile application 270 may be subscribed to receive one or more of the first and second sets of notifications 262, 264 corresponding to the associated profiles of the students. As would be understood that this way the parent may be informed as and when their child or children (that is, the student) have reached a particular designated location (assigned strategic location), for example, the parent may receive a notification on their mobile device, with the mobile application 270 installed and subscribed, when their child has reached the school premises 110, attended a particular class (if subscribed to), reached back his/her stop 130; and also information like the expected time of arrival or any delay, etc. The mobile application 270 may further be configured to display current location on a map or any other relevant information related to the whereabouts of the subscribed student. The mobile application 270 may further be configured to be in communication with the database 220 to retrieve any information about the subscribed student, on request.

Further, the computer based system 140 may include a monitoring device 280 (e.g. iPhone™, iPad™, any other smartphone, tablet computer, PDA and the like). The monitoring device 280 may be associated with one of the receivers 250 in the school network 100. For example, some or each of the receivers 250 may have one monitoring device 280 associated therewith. Specifically, the monitoring device 280 may be provided in the school buses 120. The monitoring device 280 may be configured to be in communication with the database 220 to retrieve and display a list of one or more students. The retrieved list of students may be based on one of the one or more assigned strategic locations that falls in the route plan of the bus 120. For example, if the school bus 120a is planned to serve students with the stops 130a, 130b; then the monitoring device 280 retrieved the list of the students with their assigned strategic location being one of the stops 130a, 130b.

It may be understood that the monitoring device 280 retrieves the said list based on the second signal ‘S2’ of the associated receiver 250. The said list may allow an operator of the monitoring device 280 (which in most cases, will be the driver of the bus 120) to validate students who have entered or exited at the assigned strategic location and further to alert the operator if one or more of the students have not entered or exited at the assigned strategic location. In some examples, the monitoring device 280 may store the said list in local storage for quick retrieval. It may be understood that the monitoring device 280 may include an operator application (not shown) which allows the operator to retrieve the said list, either from the database 220 or the local storage. The operator application may provide access to the list once the operator has logged in to the application by inputting and verifying the provided credentials.

In an embodiment of the present disclosure, the processing unit 260 is further configured to optimize a route plan for the school bus 120 travelling between a designated stop 130 and the entrance of school premises 110. For this purpose, the processing unit 260 may utilize one or more second entries for the students having one or more assigned strategic locations on route between the stop 130 and the entrance of school premises 110. For example, the processing unit 260 may create a route planning involving skipping one or more designated stops 130 on way back from the school premises 110 based on the information, such as if any of the students have not boarded the bus in the morning for travelling from the stop 130 to the school premises 110. Further, the processing unit 260 may utilize some secondary information available for the students having one or more assigned strategic locations falling on route. For example, the relevant information may include information about leave application of the students, information about any delay in reaching the stop 130, etc. The processing unit 260 may use that information to change the route to cater to one or more stop with immediate pick-up or drop-off requirements, or skip a stop 130 in case its known that the student(s) of that particular stop is on leave for that day, to reduce the transit time, or for any other application that may help to increase the safety and/or efficiency of the school network 100.

In some embodiments of the disclosure, the identification tag 240 is a module in a smartphone, that is, the identification tag 240 is stored virtually in a memory of the smartphone carried by the student. In such embodiments, the processing unit 260 is further configured to deliver relevant information to be displayed on the smartphone in response to the first signal ‘S1’, such that the said relevant information may be based on the strategic location corresponding to the first signal ‘S1’. For example, in case the first signal ‘S1’ is indicative that the student is in the canteen 118 of the school network 100, the processing unit 260 may send information about the day's menu to the smartphone (associated with the identification tag 240) of the student.

It may be contemplated that the computer based system 140 of the present disclosure may not be limited to application/implementation in the school network 100. In one example, the system 140 may be implemented by Senior Citizen Centers, Guardians/Care-Takers, Senior Citizens and Senior Citizen Transportation companies. Such a system 140 may include two mobile applications; one for the guardian/care-taker and the other one for the driver. Senior citizens will be equipped with Low Energy Bluetooth sensor Identification Cards (similar to the identification tags 240 as discussed above). The system 140 may use both GPS and iBeacon™ technology to track the senior citizen transportation vehicle (similar to using the receiver 250 and the location sensor 252). The guardian/care-taker application will display the bus route map, and will track the senior citizen transportation vehicle in real time; and monitor, log and receive notifications as and when the senior citizen gets on or off the senior citizen transportation vehicle (similar to sending notifications 262,264 to the mobile application 260). Further, senior citizen transportation companies may be provided with business analytics tool to manage and monitor vehicle routes and traffic. In some examples, the analytics tool may be additional modules in the web based platform 230, as discussed above. Such analytics tools are well known and have not been described in detail herein for the brevity of the present disclosure.

Similarly, in another example, the computer based system 140 of the present disclosure may be used by large corporations for monitoring and tracking of various personnel working in the closed operational network 100. For example, the system 140 may be utilized by oil and gas companies. Oil and gas companies employ hundreds or thousands of personnel who are required to be transported to and from camp site/work site at remote locations on a daily basis. Usually it is the company which engages and manages the transportation facilities. Implementing the system 140 of the present disclosure, the company can monitor and track when a particular employee have boarded the bus for transportation to the worksite so his/her attendance could be marked, any frequent delays being caused by any particular employee so he/she may be suitably instructed, any delay in the transportation so that the worker's family may be notified of the same, etc.

In yet another example, the computer based system 140 of the present disclosure may be implemented to facilitate navigation of personnel (hereinafter sometimes referred to as a customer for the purpose of this example) in the closed operational network 100 (hereinafter sometimes referred to as an environment). For this purpose, the computer based system 140 may be modified to work in more general environment, rather than limiting to the school network 100 of FIG. 1. The computer based system may still validate the customer using the above discussed control scheme. Such a system may find particular application, for example, in transit systems to guide the customer to provide navigation information based on his/her current location (as determined). For example, in one embodiment, the system 140 may include two mobile applications, one for the customer (commuter) and other one for the operator (driver). The system 140 may use the GPS and the iBeacon technology to automate the validation of customers boarding any mode of transit, using the customer mobile application. The system 140 may further transmit information on the customer mobile application utilizing communication capabilities of the receivers 250. Such information may include, but not limited to, existing route offerings, ticketing options, accounts integration, and payment options to complete a transaction. Further, the system 140 may provide the operators of the environment, for example, private transportation companies with extensive business analytics toolset, which will greatly assist them in increasing efficiency, optimizing bus routes, utilization of every bus route, real-time ridership count, conducting ridership trends analysis, and enabling to offer better transit services to their customers. In the present embodiment, the web based platform 230 associated with the system 140 may be configured to analyze a plurality of the first signals ‘S1’ to provide meaningful resources, such as one or more of a customer count in a particular transit medium in the environment, a heat map indicative of traffic of the customers in the environment, etc.

It may be understood that the systems and methods of the present disclosure have even broader range applications, for example, in museums, hospitals, etc. to provide the customer with relevant information, such as floor maps, opening and closing timings, door access credentials, etc. Such control systems and corresponding schemes may be evident to a person skilled in the art in light of the above description, and have not been described in detail herein for the brevity of the disclosure.

It may be contemplated that the computer based system 140 can be used to provide storage, processing, analytics and other functionality provides value added services, such as backup for system data; synchronization and sharing of information between readers; synchronization between different smart devices applications; interfacing the system with cloud based applications; crowd mapping of tagged items; issuing a broad “amber alert” for lost items, etc.

### INDUSTRIAL APPLICABILITY

The present disclosure provides the system 140 to facilitate monitoring and tracking of personnel in the closed operational network 100, and in particular, the monitoring and tracking of students in the school network 100. The present disclosure, in general, can further be implemented to facilitate navigation of a customer in any suitable environment.

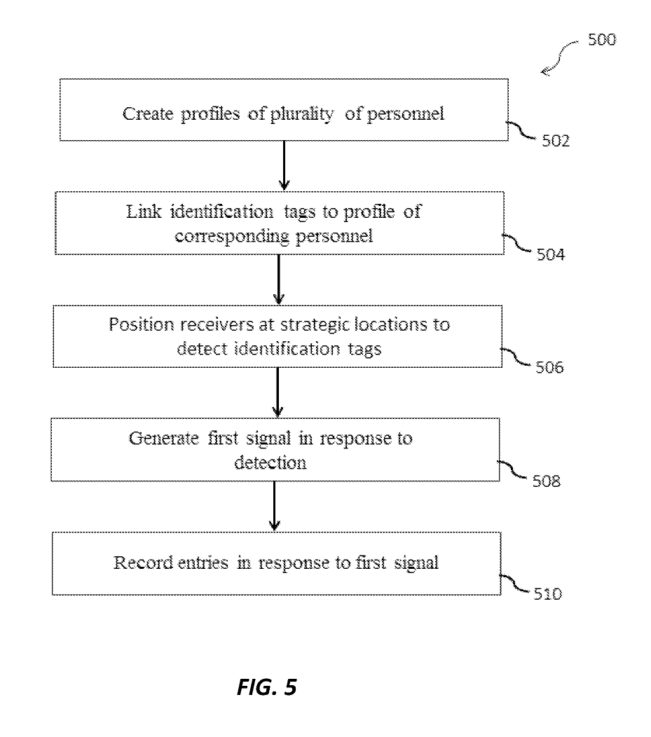

FIG. 5 illustrates steps of a method 500 implemented, over the computer based system 140, for monitoring and tracking of personnel in the closed operational network 100. At step 502, the method 500 includes creating a database 220 having profiles of a plurality of the personnel. At step 504, the method 500 includes linking the identification tag 240 to the profile of the corresponding personnel. At step 506, the method 500 includes positioning the receivers 250 at one or more strategic locations in the closed operational network 100. At step 508, the method 500 further includes generating the first signal ‘S1’ in response to the detection of the identification tag 240 in proximity of the receiver 250. At step 510, the method 500 includes recording, in the database 220, one or more first entries, indicative of the presence of the one or more personnel with respect to the one or more strategic locations, in response to the first signal ‘S1’.

The method 500 may further include steps like, storing information about one or more assigned strategic locations; determining the locations of the one or more receivers 250; generating the second signal ‘S2’ in response to the location of the receivers 250 matching with the assigned strategic locations; and recording one or more second entries, indicative of the presence of the one or more personnel with respect to the one or more assigned strategic locations, based on the first signal ‘S1’ and the second signal ‘S2’.

In one example, the present system 140 is a GPS and iBeacon technology (Bluetooth Low Energy) based student tracking system for students, to enable parents/guardians to track their children in real time during the routine school pick up and drop offs. The system 140 uses Bluetooth Low Energy beacons (sensors) attached to student's ID cards as tracking device for check-in and check-out. The present system 140 notifies the parents about the whereabouts of the bus, and thus the student, throughout the complete route, as he/she travels from the stop to the school, and vice-versa. The system 140 provides real-time tracking of the school bus as it arrives at the designated stop and travels to the school in the morning; and vice-versa in evening during drop of the student. The system 140 also allows the parents to get updates on whether their child is attending the designated classes, or may have any injury (using an alternate form of validation from the medical dispensary 118 to avoid erroneous notifications). The present system 140 further provides schools and parents with all route reports to manage their routines and pick-ups accordingly, based on the relevant data. This way the schools and parents can manage their routes, children and drivers through the system giving them complete control. The system 140 further has built-in comprehensive security protocols to ensure safety of the data and information about the student, or in general the school network 100.

The present system 140 helps to mitigate many of the concerns of the parents about the safety of their children. Parents can have a complete peace of mind as they can get real time status of their children as he/she uses school transport. Parents get notified with all updates as they happen throughout the regular transit of their children. That is, parents get real time updates and notifications right from the time when bus starts in the morning till the time their children returns home in afternoon. They can also track the bus on map in real-time as the bus comes to pick their children or when it comes to drop them off. Further, parents can manage the route and bus information of their children using their app and can select or change the routes and buses based on their convenience, provided the school network allows the same.

It may be understood that the systems 140 and methods 500 of the present disclosure, distinguishes itself from the known systems and methods for tracking purposes. The known systems and methods generally employs BLE beacons as stationary devices installed at strategic locations and the usually the customer's smartphone is targeted with, typically, advertisements or similar information, in proximity of the beacon using BLE communication medium. In the present invention, the system 140 and method 500 integrates BLE beacons with the identification tags 240 of the student/personnel and is usually constantly moving, while the smartphone (in this case, the receiver 250) is stationary and validates the detection of the beacon in proximity thereof.

The terms and descriptions used herein are set forth by way of illustrations only and are not meant as limitations. Examples and limitations disclosed herein are intended to be not limiting in any manner, and modifications may be made without departing from the spirit of the present disclosure as defined in the appended claims. Those skilled in the art will recognize that many variations are possible within the spirit and scope of the disclosure as defined in the following claims, and their equivalents, in which all terms are to be understood in their broadest possible sense unless otherwise indicated.

1. A computer based system implemented to facilitate monitoring and tracking of personnel in a closed operational network, the system comprising:
a database configured to store and retrieve profiles of the personnel; a plurality of Bluetooth Low Energy (BLE) based identification tags, each of the plurality of identification tags being linked to the profile of one of the personnel;
one or more BLE based receivers positioned at one or more strategic locations in the closed operational network, the one or more receivers configured to generate one or more first signals in response to a detection of the one or more identification tags; and
a processing unit in communication with the database and the one or more receivers, the processing unit configured to:
receive the one or more first signals from the one or more receivers; and
record, in the database, one or more first entries indicative of a presence of the one or more personnel with respect to the one or more strategic locations, based on the one or more first signals.

2. The system of claim 1, wherein the closed operational network is a school network and the personnel are students.

3. The system of claim 2, wherein the profiles of the students further include information about one or more assigned strategic locations for each student in the school network.

4. The system of claim 3, wherein the receiver comprises a location sensor configured to generate a location signal indicative of the location of the receiver.

5. The system of claim 4, wherein the location sensor is based on one or a combination of Global Positioning System (GPS), Global Navigation Satellite System (GNSS), Galileo system, Beidou system, and triangulation or trilateration of cellular or Wi-Fi networks.

6. The system of claim 4, wherein the processing unit is further configured to:
receive the location signal from the one or more receivers;
generate a second signal in response to a location of the one or more receivers matching one of the assigned strategic locations; and
record, in the database, one or more second entries indicative of the presence of the student with respect to the one or more assigned strategic locations for the corresponding student, based on the first signal and the second signal.

7. The system of claim 6, wherein the processing unit is further configured to:
generate a first set of notifications having information about the one or more students entering or exiting the one or more assigned strategic locations, based on the one or more second entries; and
generate a second set of notifications having information about one or more of a current location of the student, an expected arrival time of the student at the assigned strategic location, and updates due to any delay in the expected arrival time, based on the first signal and the location signal.

8. The system of claim 7 further comprising, a mobile application configured to be associated with the one or more profiles of the students, the mobile application configured to receive one or more of the first and second sets of notifications corresponding to the associated profiles of the students.

9. The system of claim 6 further comprising, a monitoring device associated with at least one of the receivers, the monitoring device configured to be in communication with the database to retrieve and display a list of students corresponding to one of the one or more assigned strategic locations based on the second signal of the associated receiver, to allow an operator of the monitoring device to validate students who have entered or exited at the assigned strategic location and further to alert the operator if one or more of the students have not entered or exited at the assigned strategic location.

10. The system of claim 6, wherein the strategic locations include one or more of; an entrance and exits of one or more school buses transporting the students between one or more stops and entrance of school premises, entrance of one or more classrooms in the school premises, entrance of canteen in the school premises and entrance of sports hall in the school premises.

11. The system of claim 10, wherein the assigned strategic locations include one or more of; the entrance and exits of one or more school buses, the entrance of one or more classrooms, the entrance of canteen, the entrance of sports hall, the one or more stops, and the entrance of school premises.

12. The system of claim 11, wherein the processing unit is further configured to optimize a route plan for the school bus travelling between one of the stops and the entrance of school premises, based on the one or more second entries for the students having one or more assigned strategic locations on route between the stop and the entrance of school premises.

13. The system of claim 1, wherein the identification tag is an iBeacon integrated with an identification card carried by the personnel and configured to transmit BLE signals, and wherein the receiver is a module of a smartphone and configured to communicate with the iBeacon.

14. The system of claim 1 further comprising, a web-based platform configured to provide access for managing the database.

15-18. (canceled)

19. A computer based system implemented to facilitate navigation of personnel in a closed operational network, the system comprising:
a plurality of Bluetooth Low Energy (BLE) based identification tags, each of the plurality of identification tags associated with each of the personnel;
one or more BLE based receivers positioned at one or more strategic locations in the closed operational network, the one or more receivers configured to detect the identification tags in proximity thereof, the one or more receivers configured to generate a first signal in response to a detection of the identification tag; and
a processing unit in communication with the one or more receivers, the processing unit configured to deliver navigation information to a display associated with the identification tag of the personnel in response to the first signal, the navigation information being based on the strategic location corresponding to the first signal.

20. The system of claim 19 further comprising, a web-based platform configured to analyze a plurality of the first signals to provide information about one or more of a personnel count in a particular transit medium in the closed operational network and a heat map indicative of traffic of the personnel in the closed operational network.
